(19) United States
(12) Patent Application Publication
(10) Pub. No.: US 2016/0158963 A1
(43) Pub. Date: Jun. 9, 2016

(54) MAGNESIUM-OXIDE BASED CONSTRUCTION PANEL AND PROCESS FOR MANUFACTURING SAME

(71) Applicant: Chu & Son Inc., New York, NY (US)

(72) Inventors: Eddie Wai Ho Chu, New York, NY (US); Wesley Jin Bong Lai, New York, NY (US)

(21) Appl. No.: 14/564,388

(22) Filed: Dec. 9, 2014

(51) Int. Cl. B28B 1/52; B28B 17/00; E04B 1/10; B32B 21/02; B32B 21/04; B32B 21/14; B28B 11/04; B28B 3/12

(52) U.S. Cl. CPC B28B 1/525; B28B 11/048; B28B 17/0036; B28B 3/123; B32B 21/02; B32B 21/042; B32B 21/14; E04B 1/10; B32B 2264/102; B32B 2419/04; B32B 2419/06; B32B 2607/00

(57) ABSTRACT

A construction panel is formed from a composition comprising one or more of the following ingredients: magnesium oxide, recycled magnesium oxide, fibrous chips, wood chips, bamboo chips, chemical additive and water. A method of manufacturing the construction panel is also disclosed to include mixing magnesium oxide, recycled magnesium oxide, fibrous chips and chemical additive in an aqueous solution to form a semi-arid mixture, and pouring the mixture through a funnel onto a conveyor belt. The conveyor belt passes the mixture through a series of rollers to spread the mixture out evenly in a layer and remove excess liquid. The layer is then cut into panels, which are heat by solar energy before being passing through a spray jet of dried magnesium oxide, and stacked.

### BACKGROUND OF THE INVENTION

1. Field of the Invention

The present invention relates generally to panels used in building construction, and in particular, to such panels which are formed by mixing a plurality of substances, including magnesium oxide, into a layer and caused to quickly set and thereby form a panel which can be used for structural purposes.

2. Description of the Related Art

Currently known construction panels are formed of a combination of inorganic magnesium compounds, wood fibers, perlite, chemical additives, water and other substances which, after being mixed, are extruded onto a supporting surface on top of a PVC mold, between layers of glass fabric. The wet slurry mix is cut to the exact size of the mold and placed within the mold and then delivered on top of a movable metal rack to a curing room or space for drying. The mix is set to dry within the mold for several hours at room temperature. After which, the board is separated from the mold and left in a stack for several more hours to further dry. The panels are then trimmed and sanded to a uniform thickness and the process is complete.

It is apparent that several problems exist with the current process including that it is very costly and unduly lengthy. Considerable manpower is required over the course of several days. A large amount of space is necessary for storing the panels during curing. The glass fabric used for reinforcing the strength of the panel is costly and accounts for approximately twenty percent of the total cost of the raw materials required.

Furthermore, the current process represents a considerable amount of economic waste, including the raw materials wasted when the panels are trimmed and sanded.

Moreover, the construction panels suffer from a number of structural and environmental shortcomings. The magnesium chloride incorporated in the panel composition allows for leaching and breeding, substantially weakening the material. The flexural and shear strengths are also such that they leave the panels vulnerable to cracking or splitting. The glass fabric used, although alkaline resistant, eventually erodes the fabric gradually weakening the panels.

Thus, a faster, cost-friendly, environmentally conscience process resulting in a more stable product is highly desired.

It is, therefore, a primary object of the present invention to provide an improved magnesium oxide panel, and process for creating such panel, in a cost-efficient manner to increase the rate of manufacture and product turnover, while simultaneously decreasing avoidable cost.

It is another object of the present invention to provide an improved panel that presents a lower risk of cracking or splitting by having increased flexural and shear strength, is recyclable, and simultaneously increases the numerous positive characteristics that make the existing construction panels exceptional wallboards in the construction industry today.

It is another object of the present invention to provide an improved panel that twice as strong as the existing construction panels, while still maintaining superior resistance and durability to damage from fire and water.

It is another object of the present invention to provide an improved panel comprising a small percentage of magnesium oxide, low grade or recycled material, bamboo chips, chemical additive and water.

It is another object of the present invention to provide an improved panel no longer comprising glass fabric, magnesium chloride, neutralizing chemical additives, and perlite.

It is another object of the present invention to provide an improved panel free of leaching or breeding issues.

It is another object of the present invention to provide an improved panel comprising environmentally-friendly recycled material including dust after sanding, trimmings, and broken panels.

It is another object of the present invention to manufacture an improved panel with substantially desirable properties in a single day.

It is another object of the present invention to manufacture an improved panel in a process that bonds the semi-arid mix under pressure, in lieu of heat.

It is another object of the present invention to manufacture an improved panel in a process free of molds and racks.

### BRIEF SUMMARY OF THE INVENTION

In accordance with one aspect of the present invention, a manufactured panel is provided comprising a mixture of high purity magnesium oxide, low purity magnesium oxide, fibrous chips, and chemical additive dissolved in an aqueous solution. The high purity magnesium oxide may have a purity of at least 79%. The low purity magnesium oxide may have a purity of at least 20%. The low purity magnesium oxide mixture may further comprise recycled manufactured panels. The fibrous chips may be from the group consisting of wood and bamboo chips. The manufactured panel may be used to construct load bearing walls, non-load bearing walls, ceilings, roofing, siding, insulated walls, and tile backer.

In accordance with an additional embodiment a manufactured panel is provided comprising at least 5% magnesium oxide, at least 50% recycled magnesium oxide, at least 40% fibrous chips, and at least 5% chemical additive in an aqueous solution. The recycled magnesium oxide material may include recycled manufactured panel material. The fibrous chips may be from the group consisting of wood and bamboo chips.

In accordance with an additional embodiment, a method of manufacturing a construction panel is provided comprising preparing a semi-arid mixture of high purity magnesium oxide, low purity magnesium oxide, fibrous chips, and chemical additive in an aqueous solution. Then, pouring the semi-arid mixture through a funnel and dispensing the semi-arid mixture from the funnel onto a conveyor belt. Next, passing the dispensed semi-arid mixture through a roller, where the roller is configured to press and spread the semi-arid mixture against the conveyor belt to a layer of desired uniform thickness. Then, pressing the layer through a compressor, where the compressor is configured to remove excess liquid from the layer, before cutting the compressed layer into panels of predetermined length. The high purity magnesium oxide may have a purity of at least 79%. The low purity magnesium oxide may have a purity of at least 20%. The low purity magnesium oxide mixture may further comprise recycled manufactured panels. The fibrous chips may be from the group consisting of wood and bamboo chips.

The method may further comprise drying the panels, heating the panels to a desired temperature, and heating the panels by solar energy.

The method may further comprise passing the panels through a jet, where the jet is configured to spray dry magnesium oxide on the panels, and stacking the panels.

In accordance with an additional embodiment, a system for manufacturing a construction panel is provided comprising means for preparing a semi-arid mixture of high purity magnesium oxide, low purity magnesium oxide, fibrous chips, and chemical additive in an aqueous solution. The system includes means for dispensing the semi-arid mixture onto a conveyor belt, and means for spreading the semi-arid mixture against the conveyor belt to a layer of desired uniform thickness. The system includes means for removing excess liquid from the layer and means for cutting the layer into panels of predetermined length.

The system may further comprise means for drying the panels, means for spraying dry magnesium oxide onto the panels, and means for stacking the panels.

### BRIEF DESCRIPTION OF THE SEVERAL VIEWS OF THE DRAWINGS

To these and to such other objects that may hereinafter appear, the present invention relates to improved magnesium-oxide based construction panels and the process for manufacturing same as described in detail in the following specification and recited in the annexed claims, taken together with the accompanying drawings, in which like numerals refer to like parts in which:

FIG. 1 is a perspective view of a construction panel in accordance with the preferred embodiment of the present invention;

FIG. 2 is a cross-sectional view of the construction panel taken along line 2-2 of FIG. 1;

FIG. 3 is a flow chart of the preferred method of fabricating the construction panel in accordance with the present invention;

FIG. 4A is a cross-sectional view of a first step in the process for manufacturing construction panels, showing the mixture being poured through a funnel;

FIG. 4B is a cross-sectional view of a second step in the process for manufacturing construction panels, showing the mixture being spread onto the conveyor belt;

FIG. 4C is a cross-sectional view of a third step in the process for manufacturing construction panels, showing the mixture being compressed into a layer onto the conveyor belt;

FIG. 4D is a cross-sectional view of a fourth step in the process for manufacturing construction panels, showing the layer being cut into panels;

FIG. 4E is a cross-sectional view of a fifth step in the process for manufacturing construction panels, showing the panel passing through at least one tunnel and heated; and

FIG. 4F is a cross-sectional view of a six step in the process for manufacturing construction panels, showing the conveyor passing the panel through a jet spraying dry magnesium oxide, before discarding the panel onto a stack.

To the accomplishment of the above and related objects the invention may be embodied in the form illustrated in the accompanying drawings. Attention is called to the fact, however, that the drawings are illustrative only. Variations are contemplated as being part of the invention, limited only by the scope of the claims.

### DETAILED DESCRIPTION OF THE INVENTION

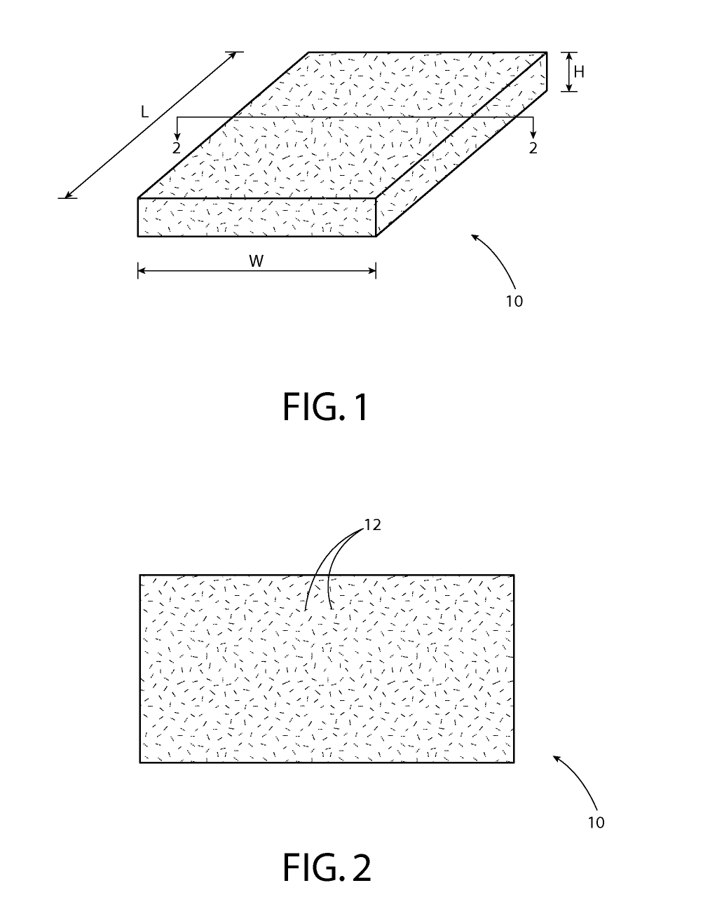

Referring now to FIG. 1, there is shown an improved construction panel 10 in accordance with the preferred embodiment of the present invention. The panel 10 includes a length L, width W and height H, which may be varied to suit particular needs.

The construction panel 10 may be used in a variety of ways during the fabrication of a house or other type of structure. Without limitation, the construction panels 10 are used for constructing floors, walls, roofing, siding, and ceilings. By varying the height H of the panels, the constructed walls may be load bearing or non-load bearing.

The construction panel 10 is made from a composition comprising one or more of the following ingredients, magnesium oxide (MgO), recycled magnesium oxide, fibrous chips, wood chips, bamboo chips, water, and chemical additive.

In the preferred embodiment, the panels 10 are made using recycled magnesium oxide materials that are ground up excess portions (e.g. scraps) from prior fabrication processes. That is, as the panels are cut to size, sanded and trimmed, the leftover scraps and shavings are ground up and reused to make future panels. In the below table, the row labeled “New MgO” refers to the ingredients used to make the panels without reusing leftover board scraps from prior fabrication processes. The “New MgO” has a preferred purity of at least 79%. The row labeled “Recycled MgO” refers to ingredients used to make construction panels while reusing leftover panel scraps from prior manufacturing processes. The row labeled “Bamboo chips” refers to ingredients produced from a machine, which creates chips using the whole bamboo. In the preferred embodiment, the construction panel comprises ingredients listed below in Table 1.

TABLE 1
(preferred embodiment)

| Ingredients | Weight Range (%) |
|---|---|
| New MgO | 5% |
| Recycled MgO | 50% |
| Bamboo Chips | 40% |
| Chemical additive in aqueous | 5% |
| solution | |

In alternate embodiments, recycled MgO may be replaced with low-grade material having purity as low as 20%. In addition, bamboo chips may be replaced with wood or other fibrous chips. In one such alternate embodiment, the construction panel comprises ingredients listed below in Table 2.

TABLE 2
(alternative embodiment)

| Ingredients | Weight Range (%) |
|---|---|
| New MgO | 5% |
| Low-grade material | 50% |
| Fibrous Chips | 40% |
| Chemical additive in aqueous | 5% |
| solution | |

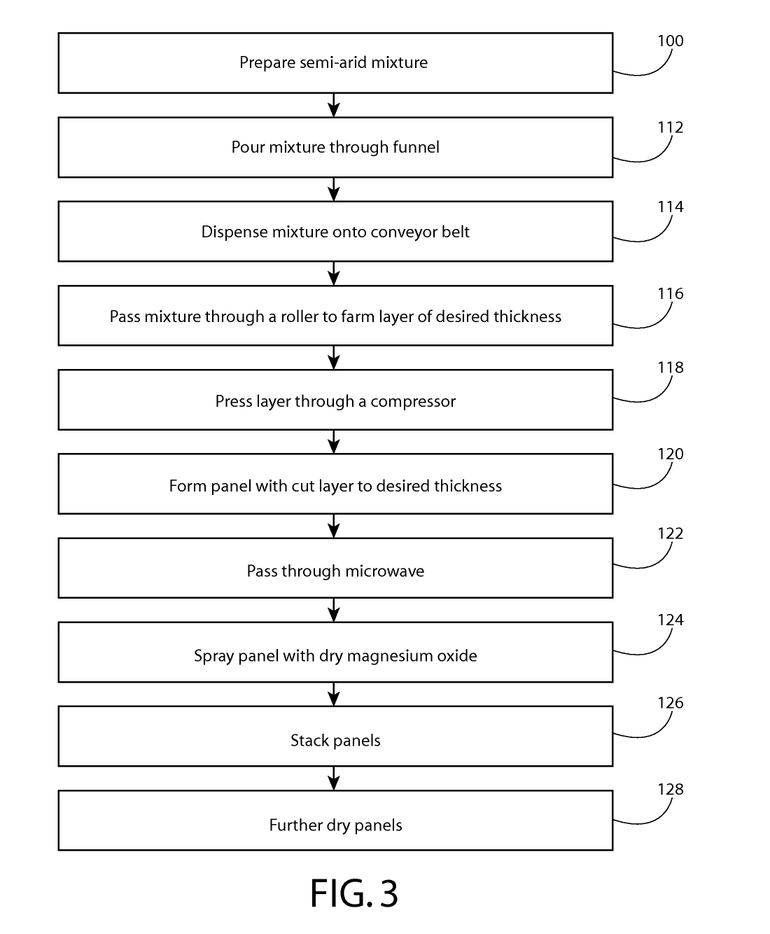

FIG. 2 illustrates a cross-sectional view of the panel 10, which generally comprises the composition of various ingredients described above. As illustrated, the construction panel 10 is composed of one single layer of mixed ingredients having varying particle size, including fibrous or bamboo chips 12. The preferred composition calls for ingredients within a very large range of particle size. Normally, the smaller the particle size the better the composition, and the better the composition the more expensive the product. However, the present process is able to utilize ingredients having a much larger and variable particle sizes in order to provide a panel composition with superior quality. In addition, the single panel layer 10 no longer requires fiberglass fabric or sheet layers above and/or below the panel 10.

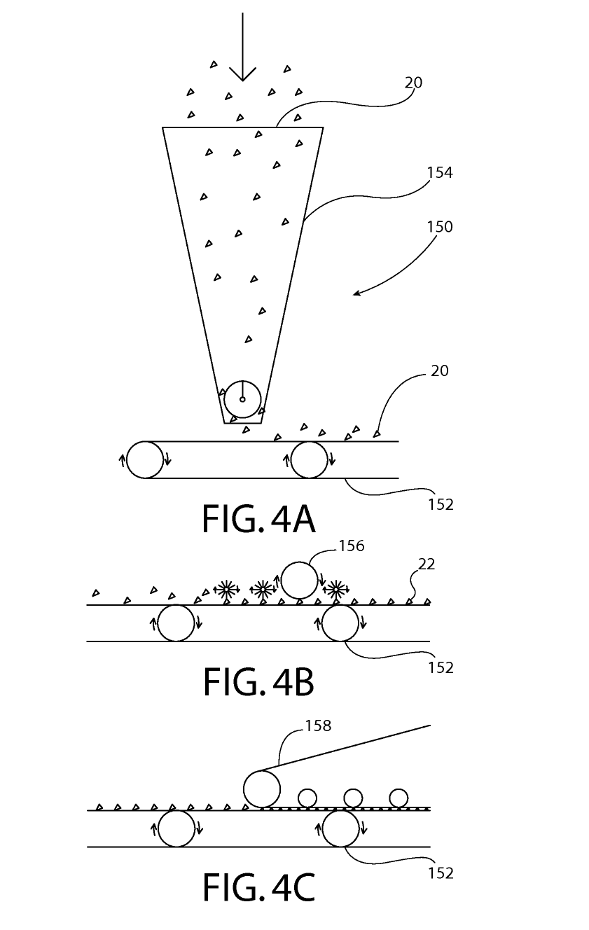

FIG. 3 illustrates the preferred method 100 for fabricating the construction panel 10 of the present invention. The method 100 includes a plurality of steps 112-128. The order of these steps may be varied and at least some of the steps are performed sequentially and may be formed concurrently.

The first step 110 of the method 100 includes mixing magnesium oxide with low grade or recycled board materials, and preferably fibrous or bamboo chips, and a chemical additive in an aqueous solution to create a semi-arid mixture. The second step 112 involves pouring the semi-arid mixture through a funnel. In the third step 114, the semi-arid mixture is dispensed through the funnel onto a conveyor belt. In the fourth step 116, the dispensed mixture is passed through a first roller. The first roller is configured to press the semi-arid mixture against the conveyor belt and form a panel layer of desired thickness. The fifth step 118 involves pressing the layer through a compressor, where the compressor is configured to remove excess liquid from the layer and compress the layer to a desired thickness. In the sixth step 120, the compressed layer is cut using a cutting blade, into panels of predetermined length. In the seventh step 122, the panels are cured by mild heat. Preferably, the conveyor belt delivers the panels to through tunnel, which exposes the panels to drying by at least one tunnel providing solar energy in order to raise the temperature of the panels from 30 degrees Celsius to 60 degrees Celsius plus or minus 5 degrees. After the panels pass through the solar energy in the tunnel, they are approximately 85% dry. In the eighth step 124, the panels pass through a powder puffing jet, where dry magnesium oxide is sprayed from the jet onto the panels. In the ninth step 126, the panels exit the conveyor belt and are stacked by a stacking machine on top of one another. Additional steps 128 may include further curing when the ambient temperature is warm or hot. Under extreme weather elements, it may take additional time for the panels to dry and cure 100%. However, even when the ambient temperature is as low as 6 degrees Celsius, it usually only takes a few hours for the panels to completely cure.

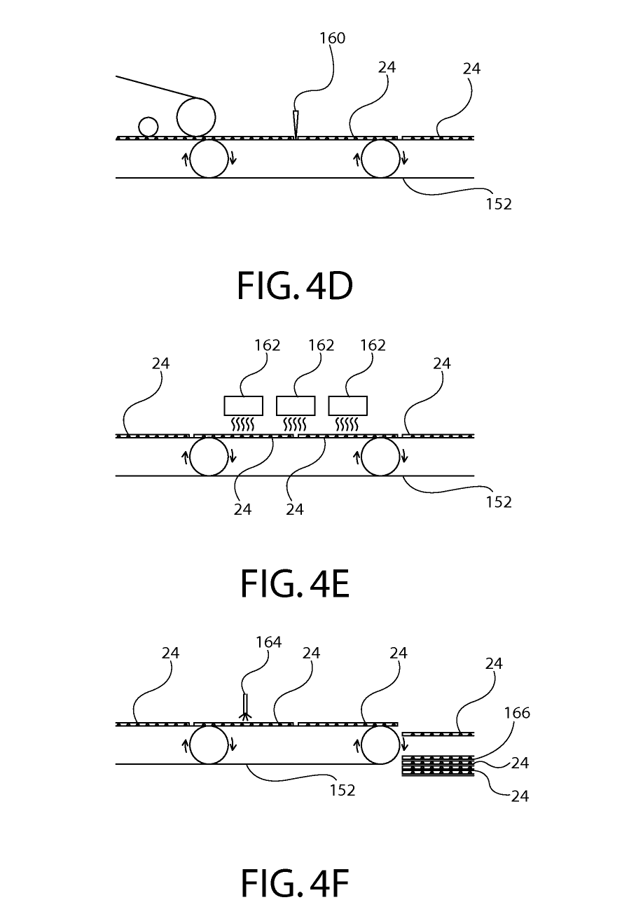

FIGS. 4A-4F illustrate a system including a variety of steps within the production line assembly process 150 for manufacturing the construction board 10. In the preferred embodiment, the process 150 includes the conveyor belt 152 for transporting the mixture through the plurality of actions 112-128. In alternate embodiments, the conveyor belt may be substituted for other methods of transport by and between steps of the methods. Once mixed, the semi-arid mixture 20 is poured through the funnel 154 or hopper and dispensed from the funnel 154 onto the conveyor belt 152. The conveyor belt 152 transports the semi-arid mixture 20 to the roller 156 or spreader in order to form a layer 22 of desired thickness. Next, the layer 22 travels by conveyor belt 152 to the compressor 158, and is pressed to remove excess liquid therefrom. The conveyor belt then transports the panel 24 to the cutter 160 and cuts the layer into panels 24 of desired dimensions. The panel 24 is then dried by passing through at least one tunnel providing solar energy 162, before passing a spray jet 164 and being sprayed with dry magnesium oxide. Once sprayed, the panels 24 are stacked 166 for storage or transport by a stacking machine.

In conclusion, herein is presented improved magnesium-oxide based construction panels and the process for manufacturing same. The invention is illustrated by example in the drawing figures, and throughout the written description.

It should be understood that numerous variations are possible, while adhering to the inventive concept. Such variations are contemplated as being a part of the present invention.

While only a limited number of preferred embodiments of the present invention have been disclosed for purposes of illustration, it is obvious that many modifications and variations could be made thereto. It is intended to cover all of those modifications and variations, which fall within the scope of the present invention as defined by the following claims.

We claim:

1. A manufactured panel comprising a mixture of:
high purity magnesium oxide;
low purity magnesium oxide;
fibrous chips; and
chemical additive dissolved in an aqueous solution.

2. The manufactured panel of claim 1, wherein the high purity magnesium oxide has a purity of at least 79%.

3. The manufactured panel of claim 1, wherein the low purity magnesium oxide has a purity of at least 20%.

4. The manufactured panel of claim 3, wherein the low purity magnesium oxide mixture further comprises recycled manufactured panels.

5. The manufactured panel of claim 1, wherein the fibrous chips are from the group consisting of wood and bamboo chips.

6. The manufactured panel of claim 1, wherein the manufactured panel comprises load bearing walls, non-load bearing walls, ceilings, roofing, siding, insulated walls, and tile backer.

7. A manufactured panel comprising:
at least 5% magnesium oxide;
at least 50% recycled magnesium oxide;
at least 40% fibrous chips; and
at least 5% chemical additive in an aqueous solution.

8. The manufactured panel of claim 7, wherein the recycled magnesium oxide material includes recycled manufactured panel material.

9. The manufactured panel of claim 7, wherein the fibrous chips are from the group consisting of wood and bamboo chips.

10. A method of manufacturing a construction panel comprising:
a. preparing a semi-arid mixture of high purity magnesium oxide, low purity magnesium oxide, fibrous chips, and chemical additive in an aqueous solution;
b. pouring said semi-arid mixture through a funnel;
c. dispensing said semi-arid mixture from said funnel onto a conveyor belt;
d. passing the dispensed semi-arid mixture through a roller, where the roller is configured to press and spread said semi-arid mixture against the conveyor belt to a layer of desired uniform thickness;
e. pressing the layer through a compressor, where the compressor is configured to remove excess liquid from said layer; and
f. cutting said compressed layer into panels of predetermined length.

11. The method of claim 10, wherein the high purity magnesium oxide has a purity of at least 79%.

12. The method of claim 10, wherein the low purity magnesium oxide has a purity of at least 20%.

13. The method of claim 12, wherein the low purity magnesium oxide mixture further comprises recycled manufactured panels.

14. The method of claim 10, wherein the fibrous chips are from the group consisting of wood and bamboo chips.

15. The method of claim 10 further comprises drying the panels.

16. The method of claim 15 further comprising heating the panels to a desired temperature.

17. The method of claim 16 wherein the panels are heated by solar energy.

18. The method of claim 10, further comprising:
passing the panels through a jet, where the jet is configured to spray dry magnesium oxide on the panels; and
stacking the panels.

19. A system for manufacturing a construction panel comprising:
a. means for preparing a semi-arid mixture of high purity magnesium oxide, low purity magnesium oxide, fibrous chips, and chemical additive in an aqueous solution;
b. means for dispensing said semi-arid mixture onto a conveyor belt;
c. means for spreading said semi-arid mixture against said conveyor belt to a layer of desired uniform thickness;
d. means for removing excess liquid from said layer; and
e. means for cutting said layer into panels of predetermined length.

20. The system of claim 19 further comprising:
means for drying said panels;
means for spraying dry magnesium oxide onto said panels; and
means for stacking said panels.
